(19) United States
(12) Patent Application Publication
(10) Pub. No.: US 2018/0089951 A1
(43) Pub. Date: Mar. 29, 2018

(54) Gaming Apparatus And Systems

(71) Applicant: Games Lab Pty Limited, Sydney (AU)

(72) Inventor: Benjamin James Ellis, Sydney (AU)

(21) Appl. No.: 15/809,672

(22) Filed: Nov. 10, 2017

Related U.S. Application Data
(63) Continuation of application No. 14/460,570, filed on Aug. 15, 2014, now abandoned.

(30) Foreign Application Priority Data
Aug. 16, 2013 (AU) 2013216693

(51) Int. Cl. G07F 17/32

(52) U.S. Cl. CPC G07F 17/3267

(57) ABSTRACT

A method of gaming comprises displaying play of a game having a feature event which is triggerable through play of the game. The feature event has a base award value, which may be either a potential award value or an actual award value. Responsive to determining a trigger for the feature event, the player is provided with an opportunity to reject the feature event prior to initiating play of the feature event, such that following said rejection by the player one or more award parameters of the feature event are configured so as to increase the award value of the feature event for a subsequent triggering thereof.

### CROSS REFERENCE TO RELATED APPLICATIONS

This application is a continuation of U.S. application Ser. No. 14/460,570, filed Aug. 15, 2014, which claims the benefit under 35 U.S.C. § 119 of Australian Patent Application No. 2013216693, filed Aug. 16, 2013, which are hereby incorporated by reference in their entireties.

### FIELD OF THE INVENTION

The present invention relates to gaming systems, game controllers and methods of gaming. It relates for example to electronic gaming machines and to networked gaming systems, such as Internet-based gaming systems.

### BACKGROUND OF THE INVENTION

Gaming machines have been a popular form of entertainment for many years. This popularity has been enhanced with the advent of electronic gaming machines and computer-based gaming systems, such as are provided over the Internet.

Many different types of game are playable on such gaming machines. They include for example standard slot-machine type games with spinning reels, poker machines, keno, bingo, blackjack, roulette, pachinko and the like.

A user will typically place a bet to begin a game, and will win or lose based upon the rules of the game.

While such games provide users with enjoyment, the need exists for alternative gaming systems in order to maintain or increase player enjoyment.

### SUMMARY OF THE INVENTION

According to a first aspect there is provided a method of gaming comprising: displaying play of a game having a feature event which is triggerable through play of the game, the feature event having one of an actual or potential base award value; and responsive to determining a trigger for the feature event, providing the player with an opportunity to reject the feature event prior to initiating play of the feature event, such that following said rejection by the player the method further comprises configuring one or more award parameters of the feature event so as to increase the award value of the feature event relative to the base value for a subsequent triggering thereof.

In an embodiment the method further comprises providing the player with an opportunity to reject one or more subsequent triggers of the feature event such that following each rejection by the player the award parameters are set such that the award value for the feature event is increased relative to the previous value.

In an embodiment the method further comprises preventing the player from rejecting any further triggered feature events responsive to the player rejecting a predefined number of triggers of the feature event, the predefined number being greater than 1.

In an embodiment the method further comprises resetting the award value for the feature event to the base award value responsive to a subsequently triggered feature event being initiated.

In an embodiment the method further comprises initiating a rejected feature event with the corresponding award value responsive to receiving a player instruction prior to the triggering of a subsequent feature event.

In an embodiment the award value is an actual value of one or more prizes awardable in the feature game.

In an embodiment the award value is a potential award value for the game.

In an embodiment the feature event comprises one or more free games and wherein the potential award value of the feature event is increased by increasing a number of the free games.

In an embodiment the feature event comprises one or more free games and wherein the potential award value of the feature event is increased by increasing or introducing a number and/or value of special symbols in the free games.

In an embodiment the feature event comprises one or more free games and wherein the potential award value of the feature event is increased by increasing a likelihood of being awarded a special prize in the free games.

In an embodiment the feature event comprises one or more free games and wherein the potential award value of the feature event is increased by increasing or introducing a prize multiplier applied during the free games.

In an embodiment the feature event comprises a selection based bonus game and wherein the award value is increased by increasing a number of player selectable objects for determining prize outcomes in the bonus game.

In an embodiment the feature event comprises a selection based bonus game and wherein the award value is increased by increasing a value of prizes associated with objects selectable by the player for determining prize outcomes in the bonus game.

In an embodiment the feature event comprises a selection based bonus game and wherein the award value is increased by increasing or introducing a number of special prizes associated with objects selectable by the player for determining prize outcomes in the bonus game.

In an embodiment the method further comprises requiring a player to place a wager which is supplementary to a wager placed on the game in order to be eligible to be awarded the feature event in response to determining that the trigger has occurred.

In accordance with a second aspect there is provided a gaming apparatus comprising: a display module operable to display play of a game having a feature event which triggerable through play of the game, the feature event having one of an actual or potential base award value; and a feature configuration module operable to receive a player instruction to reject a triggered feature event prior to play of the feature event, such that responsive to receiving the player instruction the configuration module is operable to configure one or more award parameters of the feature event so as to increase the award value for the feature event from the base value for a subsequent triggering thereof.

In an embodiment the feature configuration module is operable to receive a player instruction to reject one or more subsequent triggers of the feature event such that following each rejection by the player the configuration module increases the award value for the feature event relative to the previous value.

In an embodiment the feature configuration module is further operable to automatically award a triggered feature event responsive to determining that a predefined number of triggered feature events have been rejected by the player, the predefined number being greater than 1.

In an embodiment the feature configuration module is further operable to reset the award value for the feature event back to the base value responsive to awarding a subsequently triggered feature event.

In an embodiment the feature configuration module is further operable to award a rejected feature event to the player responsive to receiving a player reversal instruction prior to the triggering of a subsequent feature event.

In accordance with a third aspect there is provided a gaming system comprising: a gaming terminal implementing a display; and a gaming controller comprising: a display module operable to display play of a wager game on the gaming terminal display, the wager game having a feature event which is triggerable through play of the wager game, the feature event having one of an actual or potential base award value; and a feature configuration module operable to receive a player instruction to reject a triggered feature event prior to play of the feature event, such that responsive to receiving the player instruction the configuration module is operable to configure one or more award parameters of the feature event to thereby increase the award value for the feature event for a subsequent triggering thereof.

In accordance with a fourth aspect there is provided a computer program code which when executed by a computing system implements the method as described in accordance with any one of the aforementioned aspects.

In accordance with a fifth aspect there is provided a non transitory computer readable medium comprising the computer program code of the sixth aspect.

An embodiment of the system further includes a central control for running a gaming algorithm, and a plurality of remote clients in communication with the central control over a communications network, the remote clients including screens for the display of information to players.

Embodiments of the present invention may be applied to any suitable type of gaming system or platform. It can apply to stand-alone gaming apparatus, e.g. electronic gaming machines, such as video gaming machines, to gaming machines that are linked together, e.g. via a network such as an intranet, and/or to gaming systems provided through computing or other electronic devices, e.g. personal computers, PDAs, mobile telephones, tablets, digital televisions, and the like, e.g. over the Internet or other communications networks.

Embodiments may be applied to gaming apparatus that play any suitable wager or non-wager based game, but especially relate to slot-machine type games.

In some networked embodiments of the invention, the central control may conduct the games and manage the accounting and the like, and a number of remote terminals/clients merely provide the user input and display mechanisms. In other networked embodiments of the invention, the control of the games and various other features may be carried out at the remote terminals, or may be split between the central control and the remote terminals.

### BRIEF DESCRIPTION OF THE ACCOMPANYING DRAWINGS

Embodiments of the invention will hereafter be described, by way of example only, with reference to the accompanying drawings, in which:

FIG. 1 is a block diagram of gaming apparatus according to one embodiment of the present invention;

FIG. 2 is a schematic of a game controller according to an embodiment; and

FIG. 3 is a flow diagram of a gaming control process in accordance with an embodiment of the present invention.

### DETAILED DESCRIPTION

In an embodiment a game controller of a gaming device comprises a display module operable to provide the display of a wager game having a feature event. The feature event has a base award value and is awarded to a player responsive to a trigger occurring through play of the wager game. The base award value may be either an actual award value, or a potential award value. A feature configuration module implemented by the game controller is operable to receive a player instruction to reject a triggered feature event prior to play of the feature event, such that responsive to receiving the player instruction the configuration module is operable to configure one or more award parameters of the feature event to thereby increase the award value from its base value for a subsequent triggering thereof. Upon the eventual awarding of the feature event the award value is returned to the base value.

### General Construction of a Gaming System

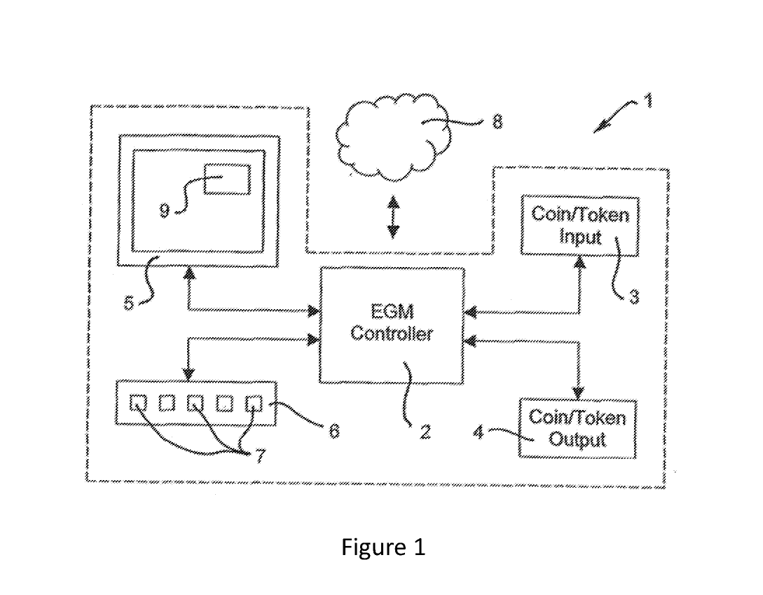

Referring to FIG. 1 there is shown a gaming apparatus, which in this case takes the form of an electronic gaming machine (EGM) 1, and which includes various standard components, such as a game controller 2 for controlling the operation of the EGM 1 and the games run on it, a note/coin/token input 3 for receiving bets, a note/coin/token output 4 for paying out winnings, one or more displays 5 for displaying game screens, and player input means 6 for allowing user interaction, which may include e.g. buttons 7 and which may e.g. be provided as part of the display 5 in a touch-screen type manner. The EGM 1 also includes a player tracking and marketing means 9 having a reading device (e.g. a card scanner for reading a smart card or other form of portable storage medium capable of being read by the card scanner) which communicates with a remote server for providing player tracking and loyalty type functions, as is well understood in the art. Additional hardware may be included as part of the EGM 1, or hardware may be omitted as required by the specific implementation.

In one form the EGM 1 may be a stand-alone machine. In another form, the EGM may be networked with other EGMs and/or a control centre via a suitable communications network 8, such as a LAN and/or WAN, in order to play networked (e.g. intranet or Internet) games, such as a linked jackpot. It will be appreciated that the EGM 1 may include an appropriate communications interface, such as a network card, for communicating over the communications network 8.

In use, the EGM 1 will display an initial gaming screen on the display 5. A player will insert bank notes, coins and/or tokens into the EGM input 3 (or may be credited with coins, credits or tokens), and will press a button 7 to initiate play of the main game provided by the EGM 1. How matters then proceed will depend on the type of main game being played. For example, FIG. 4 illustrates a game screen from a slot machine-type game, in which the EGM 1 displays virtual reels 10 of symbols 11, and spins and stops these reels 10 in various win and lose symbol combinations on one or more paylines 12 in accordance with a stored gaming algorithm and a random number generator. In an alternative embodiment (not illustrated) the main game is a poker-type game, in which a player will receive a number of cards with which to play for a winning hand. It will be appreciated that other types of main games may be provided, such as keno, blackjack, bingo, roulette, pachinko, or the like. For the purposes of this detailed description, the main focus shall be upon an embodiment providing a slot machine-type main game. As used in this document, including in the claims, the terms “random”, “randomly”, “randomized”, and the like, are to be construed as connoting either a purely random process or a “pseudo-random” process. An example of a pseudo-random process includes the determination by a computer processor of a pseudo-random number in response to an output of a digital clock.

The player may interact via the buttons 7, so as e.g. to spin or hold reels and otherwise play the main game. A common element will be win events, e.g. particular symbol combinations that pay out a prize.

Also, in order to increase interest, the main game is capable of providing feature events that consist of one or more feature games, which may or may not relate directly to the main game being played, and that generally provide a prize of some sort. These feature events may include for example one or more free games, a re-spin (similar to a free game but with one or more reels held on a slot device), and the chance to play for higher winnings or the like (e.g. in a higher-payout game that may require additional wagering). They may be e.g. luck or skill based. They may be provided as “second screen” features that display on a new screen, and may be extraneous to the main game and may involve some form of player interaction. They may also provide players with an opportunity to win a special prize, such as a jackpot prize (as will be described in more detail in subsequent paragraphs) or bonus prize (e.g. an award of credits, reward points, etc.).

Another way of adding gaming interest is for a main game or a feature event to include one or more wild symbols that can represent more than one type of symbol, and so can increase the chances of achieving a winning combination or the like. Similarly, for embodiments in which the main game is a card game, wild cards may be provided.

These win and feature events can be arranged to occur due to the usual operation of the main game randomly or under a particular set of circumstances, e.g. when a predefined symbol combination occurs after a spin of the reels, or a predefined card combination occurs in a card game. They may also occur due to an accumulation of circumstances across a number of games, and may occur due to the condition of a device supplemental to the EGM 1 itself, e.g. they may relate to jackpot wins in linked jackpot systems comprising a plurality of EGMs under a central control.

FIG. 1 illustrates an essentially stand-alone EGM (albeit with the potential for networked connectivity). However, in an alternative embodiment the system may be implemented over a distributed architecture where some of the individual EGM modules are implemented remotely. For example, in one particular form, a central control computer which is located remotely of the EGM may implement a controller which controls some or all of the game play functionality (i.e. such that the EGM essentially operates as a remote client arranged to provide audible and/or visual gaming information to a player and allow player interaction with the central control computer). A plurality of EGM clients may be in communication with the central control computer over a communications network such as a local area network and/or a wide area network. In an alternative embodiment, the game play functionality may be implemented by both the EGM and central control computer such that they collectively provide a game controller.

The central control computer has access to associated memory and storage devices. The central control computer also has access to computer executable code for instructing the central control computer to run the gaming algorithm that performs the embodiment of the inventive method. In one embodiment the computer executable code is in the form of software and associated data, which are stored upon a computer-readable medium in the form of one or more compact disks. Alternative embodiments make use of other forms of digital storage media, such as Digital Versatile Discs (DVD's), hard drives, flash memory, Erasable Programmable Read-Only Memory EPROM, and the like. Alternatively, the software and its associated data may be stored as one or more downloadable or remotely executable files that are accessible via a computer communications network such as the internet.

### Detail of the Game Controller

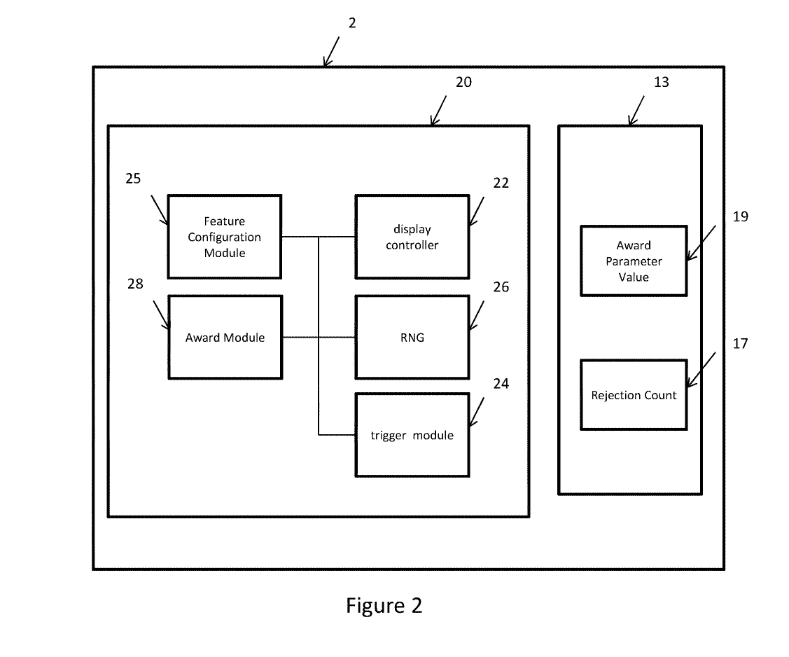

The game controller 2 of an embodiment is shown in more detail in FIG. 2. For simplicity only those modules (which may be implemented in hardware, software, or a combination of the two) needed to carry out embodiments are illustrated. Other standard and/or non-standard modules may also be implemented for carrying out operation of normal and feature game play functionality. It will be understood that the term “processor” as used herein is to be construed broadly and include within its scope any device that can process gaming algorithms and may include a microprocessor, microcontroller, programmable logic device or other computational device, a general purpose computer, or a server computer. Typically, the gaming algorithms (instructions) are stored as program code in memory 13, which is in data communication with the processor.

In the illustrated embodiment, the game controller 2 includes a processor 20 which is arranged to control play of a game having a feature event which is awardable to a player responsive to a feature trigger occurring. The game provides a feature rejection option whereby a player may elect to reject a triggered feature event prior to commencing play of the feature, thereby causing an award value of the feature event to be increased for a subsequent triggering thereof through adjustment of various award parameters. The award value that is increased through rejection of the feature event may be an actual award value and/or a potential award value, depending on the desired implementation. For example, the feature event may relate to a selection based bonus game (also referred to as a “pick a box” game) in which case a value of the underlying “hidden” prizes may be doubled (or otherwise increased in value) to thereby increase the actual award value. In another example embodiment, the actual award value of a feature event may be increased by awarding the player a bonus prize (e.g. machine credits) in addition to any randomly awarded prizes won through play of the feature event. An increase to a potential award value for a feature event may include, for example, increasing a number and/or value of special symbols (e.g. wild symbols, multipliers, jackpot triggers, etc.) which may appear during play of the feature event, increasing a number of free games and/or reel re-spins awarded to the player in the feature event, increasing a number of selectable boxes in a pick a box game, among others. It will be understood that the techniques for increasing the actual/potential award value should not be seen as limited in any way to those examples outlined above and may include any suitable technique depending on the nature of the feature event. In a particular embodiment, the player can elect to re-claim a rejected feature event (i.e. which is played with its original award value) at any time up until the feature event trigger next occurs. As mentioned above, the player must make the decision to reject or accept the feature prior to play thereof. It will be understood that “play” of the feature event may comprise spinning of physical or virtual reels in a free game feature or re-spin feature to potentially award prizes, selections being manually or automatically made within a pick-a-box feature and so forth. Thus, the player is required to make the decision as to whether to accept or reject the feature prior to any award/prize outcomes being displayed.

To facilitate the above functionality, the processor 20 implements a number of modules, based on program code stored in memory 13. A display module 22 is operable to provide the display of the game implemented by the controller 2. A trigger module 24 is arranged to set randomly occurring feature event triggers and detect their occurrence during play of the game, with the aid of a random number generator 26. A feature configuration module 25 is operable to receive player instructions for rejecting a triggered feature event and to configure award parameters thereof for setting potential or actual award values (i.e. based on feature event rejections or resets), with the current award value setting being stored in memory 13. The feature configuration module 25 is further operable maintain a feature rejection count 17 (stored in memory 13) for tracking a number of successive feature rejections by a player. An award module 28 is operable to award a triggered feature event in response to either an acceptance by the player, or an automatic awarding after a predefined number of successive rejections has been reached.

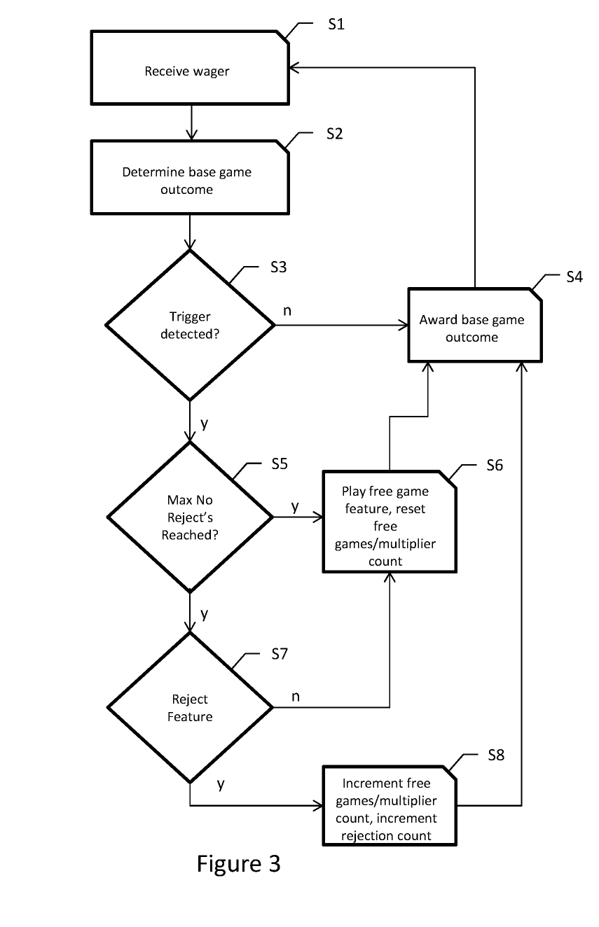

A specific embodiment will now be described with additional reference to the flowchart of FIG. 3. The flowchart assumes that the game is in the form of a reel-type game. A feature event (hereafter “free game feature”) in the form of a series of free games is triggerable during play of the reel-type game in response to a particular symbol combination randomly occurring on a played payline. According to the illustrated embodiment, a potential award value of the free game feature is increased by adjusting two different award parameters. More particularly, the potential award value is increased by increasing both a number of the free games that would have been awarded to the player if they had accepted the feature event, as well as increasing a value of a prize multiplier that is applicable for any wins in those free games. For example, the number of free games is increased from a base number of 5 free games (which also corresponds to the reset number) by five additional free games each time the free game feature is rejected by the player. The multiplier value (which starts at ×2) doubles for each rejection. According to the illustrated embodiment, the player is only allowed to reject the free game feature five times, after which the free game feature is automatically awarded upon it next triggering. It will be understood, however, that the afore-mentioned values are examples only and any values or adjustments thereof (including linear or non-linear increases) may be applicable, depending only on the desired implementation.

The number of free games and relevant multiplier at any point in time is stored in the award parameter value store 19 in memory 16. These numbers may be persistently or otherwise displayed to the player on the display screen, or by way of some other suitable display mechanism. Further, upon the free game feature being triggered the player may be notified of the increase in award value (in this case being the number of free games that will be added to the free games feature for a subsequent triggering, as well as the increase in prize multiplier), should they elect to reject the presently triggered free games feature. Again, this notification may be provided by way of the display screen or other suitable display mechanism.

At step S1 a player places a main game wager in order to play the reel game on the EGM 1. Depending on the desired implementation, the player may also be required to place a wager which is supplementary to the main game wager in order to be eligible to be awarded the free game feature(s).

At step S2, a game outcome for the base game is determined (with the aid of the RNG 26) and the result displayed to the player.

At step S3, the trigger module 24 evaluates the game outcome to ascertain whether the free game feature trigger occurred. If the trigger did not occur then the process moves to step S4 where the award module 28 awards any base game (i.e. non-free game feature) outcomes before returning to step S1.

Returning to decision step S3, in the event that a trigger is detected, the feature configuration module 25 evaluates whether the number of rejections in the rejection count 17 has reached a predefined threshold (step S5). If so, at step S6, the award module 28 awards the free games feature to the player with the applicable number of free games and multiplier value (as specified by the award parameter value store 19). Once the free game feature has finished playing (with any resulting prizes awarded), the free game and multiplier count are reset to their base value and the process returns to step S1 via step S4.

Returning to step S5, if the rejection count has not reached a predefined threshold, the player is presented with an opportunity to either accept or reject the free game feature (step S7). This may be by way of dedicated accept or reject buttons, touch screen input or any suitable means. In a particular embodiment, if after a predefined time the player has not selected an accept or reject button this may be taken as a decision by the player to accept the free game feature.

If, at step S7, the player decides to accept the feature play (either by selecting the accept button, or through not taking any action within the predefined period of time), the process returns to step S6. Otherwise, the process moves to step S8 whereby the free game number count and multiplier value are each incremented by the relevant amount and the rejection count is incremented by 1, before returning to step S1, via step S4.

It will be understood that the form of feature event should not be seen as being limited to a free games feature and could be any form of in-game feature or externally triggered and awarded feature event (e.g. the triggering of a jackpot prize such as a mystery jackpot prize, etc.), depending only on the desired implementation.

It is to be understood that various alterations, additions and/or modifications may be made to the parts previously described without departing from the ambit of the present invention, and that, in the light of the above teachings, the present invention may be implemented in software, firmware and/or hardware in a variety of manners as would be understood by a person skilled in the art.

The claims defining the invention are as follows:

1. A method of gaming comprising:
displaying play of a game having a feature event which is triggerable through play of the game, the feature event having one of an actual or potential base award value; and
responsive to determining a trigger for the feature event, providing the player with an opportunity to reject the feature event prior to initiating play of the feature event, such that following said rejection by the player the method further comprises configuring one or more award parameters of the feature event so as to increase the award value from the base award value for a subsequent triggering thereof.

2. A method in accordance with claim 1, further comprising providing the player with an opportunity to reject one or more subsequent triggers of the feature event such that following each rejection by the player the award parameters are set such that the award value for the feature event is increased relative to the previous value.

3. A method in accordance with claim 2, further comprising preventing the player from rejecting any further triggered feature events responsive to the player rejecting a predefined number of triggers of the feature event, the predefined number being greater than 1.

4. A method in accordance with claim 1, further comprising resetting the award parameters for the feature event such that the award value is reset to the base award value responsive to a subsequently triggered feature event being initiated.

5. A method according to claim 1, further comprising initiating play of a rejected feature event with the corresponding award value responsive to receiving a player instruction prior to the triggering of a subsequent feature event.

6. A method according to claim 1, wherein the award value is an actual value of one or more prizes awardable in the feature game.

7. A method according to claim 1, wherein the award value is a potential award value for the game.

8. A method in accordance with claim 7, wherein the feature event comprises one or more free games and wherein the potential award value of the feature event is increased by increasing a number of the free games.

9. A method in accordance with claim 7, wherein the feature event comprises one or more free games and wherein the potential award value of the feature event is increased by increasing or introducing a number and/or value of special symbols in the free games.

10. A method in accordance with claim 7, wherein the feature event comprises one or more free games and wherein the potential award value of the feature event is increased by increasing a likelihood of being awarded a special prize in the free games.

11. A method in accordance with claim 7, wherein the feature event comprises one or more free games and wherein the potential award value of the feature event is increased by increasing or introducing a prize multiplier applied during the free games.

12. A method according to claim 6, wherein the feature event comprises a selection based bonus game and wherein the award value is increased by increasing a number of player selectable objects for determining prize outcomes in the bonus game.

13. A method according to claim 6, wherein the feature event comprises a selection based bonus game and wherein the award value is increased by increasing a value of prizes associated with objects selectable by the player for determining prize outcomes in the bonus game.

14. A method according to claim 6, wherein the feature event comprises a selection based bonus game and wherein the award value is increased by increasing or introducing a number of special prizes associated with objects selectable by the player for determining prize outcomes in the bonus game.

15. A method according to claim 1, further comprising requiring a player to place a wager which is supplementary to a wager placed on the game in order to be eligible to be awarded the feature event in response to determining that the trigger has occurred.

16. A gaming apparatus comprising:
a processor operable to implement:
an electronic display module operable to display play of a game having a feature event which triggerable through play of the game, the feature event having one of an actual or potential base award value; and
a feature configuration module operable to receive a player instruction to reject a triggered feature event prior to play of the feature event, such that responsive to receiving the player instruction the configuration module is operable to configure one or more award parameters of the feature event so as to increase the award value for the feature event from the base value for a subsequent triggering thereof.

17. A gaming apparatus in accordance with claim 16, wherein the feature configuration module is operable to receive a player instruction to reject one or more subsequent triggers of the feature event such that following each rejection by the player the configuration module configures the award parameter(s) to increase the award value for the feature event relative to the previous value.

18. A gaming apparatus in accordance with claim 16, wherein the feature configuration module is further operable to automatically award a triggered feature event responsive to determining that a predefined number of triggered feature events have been rejected by the player, the predefined number being greater than 1.

19. A gaming apparatus in accordance with claim 16, wherein the feature configuration module is further operable to reset the award value for the feature event back to the base value responsive to awarding a subsequently triggered feature event.

20. A gaming apparatus in accordance with claim 16, wherein the feature configuration module is further operable to award a rejected feature event to the player responsive to receiving a player reversal instruction prior to the triggering of a subsequent feature event.

21. A gaming system comprising:
an electronic gaming terminal implementing a display; and
a gaming controller comprising:
a display module operable to display play of a wager game on the gaming terminal display, the wager game having a feature event which is triggerable through play of the wager game, the feature event having one of an actual or potential base award value; and
a feature configuration module operable to receive a player instruction to reject a triggered feature event prior to play of the feature event, such that responsive to receiving the player instruction the configuration module is operable to configure one or more award parameters of the feature event so as to increase the award value for the feature event for a subsequent triggering thereof.
